(19) United States
(12) Patent Application Publication
(10) Pub. No.: US 2003/0233269 A1
(43) Pub. Date: Dec. 18, 2003

(54) Computerized method and system for generating reports and diagnostics which measure effectiveness of an event or product or service promoted at the event

(76) Inventors: Grant Griffin, West Bloomfield, MI (US); Jeremy K. Lance, Wyandotte, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 10/170,305

(22) Filed: Jun. 13, 2002

(51) Int. Cl. G06F 17/60

(52) U.S. Cl. 705/10; 705/14

(57) ABSTRACT

A computerized method and system for generating reports and diagnostics which measure effectiveness of an event or product or service promoted at the event are provided. Demographic, product or service and event data are obtained from attendees of the event using a plurality of interactive, attendee-accessible data entry devices. The obtained data is stored in an attendee database. The stored data is processed to generate reports and diagnostics which measure effectiveness of the event or product or service.

### BACKGROUND OF THE INVENTION

1. Field of the Invention

This invention relates to computerized methods and systems for generating reports and diagnostics which measure effectiveness of an event or product or service promoted at the event.

2. Background Art

Events are used within many U.S. industries such as automotive, health care, information technology, media/entertainment and consumer electronics to market products and/or services. Because such events typically are often quite expensive, companies desire or often require feedback as to the effectiveness of such events in marketing their goods and/or services. For example, companies desired to know: a) what kind of return they can expect on their investment in the event; b) what kind of impact does the event have on their current and/or potential customers; c) what events they should sponsor or go to; d) the components of a successful event; and e) the components of an event that motivates purchasers of their goods and/or services.

One way of obtaining such feedback is to conduct personal interviews of the attendees who may be “intercepted” at the event. Temporary workers are typically found, hired and trained to stop, interview and record answers using “pencil and paper.” A number of problems exist with the “intercept” method as follows:

Such interviews are difficult to conduct without introducing bias;

The quality and quantity of data that can be collected is limited since the amount of time to personally ask, phrase correctly, answer and record each question/answer is large;

Interviewees tend not to answer questions regarding income, ethnicity, etc. in face-to-face interviews; and

Intercept interviews require considerable data entry time and “data cleaning” prior to the data being analyzed, reports generated and knowledge extrapolated and deduced.

U.S. Pat. Nos. 4,355,372 and 4,603,232 disclose methods for electronically collecting/accumulating related market survey data from a plurality of diverse locations by utilizing a hand-held microcomputer.

U.S. Pat. No. 5,704,029 discloses a computerized forms system and method, which appears to provide questionnaires being displayed on a personal digital assistant (PDA), and utilized for gathering event-related information.

U.S. Pat. No. 5,893,075 discloses an on-site interactive, customer-accessible data processing system, which appears to provide a customer database and means for providing/displaying a plurality of customer survey questions/data fields via a computer and a screen display. The display appears to include questions/fields asking customers for personal information such as: name, address, phone, spouse name, birthday, wedding anniversary, quality of service, opinions, preferences, why the customer chose the business, etc., and may be utilized for sending tailored promotional messages in the form of letters, phone calls, facsimiles, etc. to customers listed in the customer database.

U.S. Pat. No. 5,893,098 discloses a system for obtaining survey information from a plurality of computer users, and appears to provide a survey questionnaire document including: at least one question formulated from data input by the survey author; electronic mail transmission mechanism for transmitting the survey questionnaire document to a plurality of respondent users; a processing apparatus including a collating mechanism arranged to identify response documents; and a relational database loaded in accordance with the responses.

U.S. Pat. No. 6,177,940 B1 discloses a method for real-time data analysis for comparing individual data points against a user-specified group to generate profile reports. The system utilizes an on-site data input (questionnaire).

U.S. Pat. No. 6,298,347 B1 discloses a method for generating and distributing a questionnaire to a remote data processing unit (hand held computer) to be completed and transmitted back to a central collection/storage location in a report format.

U.S. Pat. No. 6,301,564 B1 discloses an on-site method and electronic apparatus, which appears to provide a human input interface component of application software, where patrons, employees and management provide preference survey input through to a database (relational model) in relation to a restaurant dining event. The method appears to allow events or décor to be tailored to individual preferences via reports developed as a result of the survey.

Published U.S. application No. 2001/0056374 A1 discloses an interactive survey apparatus, database and method, which appears to provide compensation to individuals who interact with surveys, marketing surveys, market research surveys, questionnaires, marketing questionnaires, market research questionnaires, etc. via telephone, e-mail, user computers, provider computers, advertiser computers and/or an information gathering entity computer.

Published U.S. patent application No. 2002/0010620 A1 discloses an information gathering method and/or system, which appears to provide means for selecting a target group of most profitable consumers of a product or service from a group of consumers contained in a database. Additionally, a questionnaire appears to be administered by telephone, Internet, mail or in the form of in-person surveys, and may further provide an assessment/calculation of a statistical relationship between consumer responses to questions and database stored customer information for representing a range of behavioral variables in relation to events (i.e., product, sporting, music concerts, etc.).

U.S. Pat. No. 6,311,190 B1 discloses a programmed computer system, which appears to provide: a meta-database having related tables storing voting information for building surveys in multiple languages; distribution means incorporating an e-mail message containing a hyperlink to the URL of a voting campaign; and means for recording survey response results in the meta-database.

U.S. Patent No. 6,349,134 B1 discloses a method for conducting polls over a telephone network.

### SUMMARY OF THE INVENTION

An object of the present invention is to provide a flexible, speedy and cost-effective method and system for generating reports and diagnostics which measure effectiveness of an event or product or service promoted at the event and which overcome many of the problems associated with the prior art.

Another object of the present invention is to provide a computerized method and system for generating reports and diagnostics which measure effectiveness of an event or product or service promoted at the event wherein attendee opinions and answers can be monitored in “real-time” to enable event “tweaking” on specific areas, especially for multi-day events. Also, such feedback can be quickly used to balance specific quotas from respondents (i.e., the need for more opinions from women, minority/diverse groups, etc.)

In carrying out the above objects and other objects of the present invention, a computerized method for generating reports and diagnostics which measure effectiveness of an event or product or service promoted at the event is provided. The method includes obtaining demographic, product or service and event data from attendees of the event using a plurality of interactive, attendee-accessible data entry devices. The method also includes storing the obtained data in an attendee database, and processing the stored data to generate reports and diagnostics which measure effectiveness of the event or product or service.

The step of storing may be performed using portable storage media or a network such as a local area network, a wireless network, a wide area network or a long range network.

The method may further include obtaining secondary product or service data from attendees of the event and storing the secondary product or service data in the attendee database.

The method may further include inducing attendees to enter personal data about themselves into the data entry devices.

The database may be a relational database.

At least one of the data entry devices may include a screen display for displaying a questionnaire and the obtained data.

Further in carrying out the above objects and other objects of the present invention, a system for generating reports and diagnostics which measure effectiveness of an event or product or service promoted at the event is provided. The system includes a plurality of interactive, attendee-accessible data entry devices for obtaining demographic, product or service and event data from attendees of the event. The system also includes an attendee database for storing the obtained data. The system further includes a processor for processing the stored data to generate reports and diagnostics which measure effectiveness of the event or product or service.

The system may include portable storage media or a network such as a local area network, a wireless network, a wide area network or a long range network.

The diagnostics are a measure of a brand's health.

The data entry devices may also obtain secondary product or service data from attendees of the event and the database may store the secondary product or service data.

The system may further include means for inducing attendees to enter personal data about themselves into the data entry devices.

The database may be a relational database.

At least one of the data entry devices may include a screen display for displaying a questionnaire and the obtained data.

The diagnostics may include an event consumer purchase funnel profile.

The funnel may include attendees' opinion and consideration levels.

The reports may include attendee purchase intention.

The reports may further include a personal recommendation rating or may include an attendee satisfaction rating.

The above objects and other objects, features, and advantages of the present invention are readily apparent from the following detailed description of the best mode for carrying out the invention when taken in connection with the accompanying drawings.

### BRIEF DESCRIPTION OF THE DRAWINGS

FIG. 1 is a block diagram flow chart illustrating the steps of obtaining demographic, product and event data, storing the obtained data in an attendee database and entering a sweepstakes;

FIG. 2a is a schematic diagram illustrating one embodiment of a computer network of the present invention;

FIG. 2b is a schematic diagram illustrating a second embodiment of a computer network of the present invention;

FIG. 2c is a schematic diagram of a third embodiment of a computer network of the present invention;

FIG. 3 is a “welcome” display screen with associated block diagram flow chart of the present invention;

FIG. 4 is a first demographic display screen and associated block diagram of the present invention;

FIG. 5a illustrates a demographic display screen with Internet question generated in response to a “yes” answer to the question shown on the display screen of FIG. 4 and associated block diagram;

FIG. 5b illustrates a demographic display screen without an Internet question generated in response to a “no” answer to the question shown on the display screen of FIG. 4;

FIG. 6a illustrates a demographic display screen with Internet question and associated block diagram flow chart generated in response to a “yes” answer to the question shown on the display screen of FIG. 5a;

FIG. 6b illustrates a demographic display screen without an Internet question generated in response to a “no” answer to the question shown on the display screen of FIG. 5a;

FIG. 7 illustrates upper and lower demographic display screens with and without spouse questions, respectively, based on the marriage information obtained in the display screen of FIG. 4 and associated flow chart of the present invention;

FIG. 8 illustrates upper and lower display screens, the upper one for a retired individual and the lower one for all attendees together with an associated flow chart and explanatory text of the present invention;

FIG. 9a illustrates a vehicle display screen based on a “new” answer to the question of the lower display screen of FIG. 8 together with explanatory text;

FIG. 9b illustrates another vehicle display screen based on a “used” answer to the question of the lower display screen of FIG. 8;

FIG. 10 illustrates the next vehicle display screen and associated explanatory text of the present invention;

FIG. 11 illustrates three vehicle display screens and associated explanatory text of the present invention wherein the display screen entered on the right of this Figure is based on the answers to prior questions;

FIG. 12 illustrates an event display screen of the present invention;

FIG. 13 illustrates the next event display screen of the present invention after the display screen of FIG. 12;

FIG. 14 illustrates the next event display screen of the present invention after the display screen of FIG. 13;

FIG. 15 illustrates the next event display screen of the present invention after the display screen of FIG. 14;

FIG. 16 illustrates a partnership display screen and associated explanatory text of the present invention;

FIG. 17 illustrates a raffle or sweepstakes display screen of the present invention;

FIG. 18 illustrates is “goodbye” display screen together with flow chart and associated explanatory text of the present invention;

FIG. 19 illustrates a diagnostic or a measure of brand health in the form of a pair of purchase funnel profiles, the left funnel profile being a national funnel profile and the right funnel being an event funnel profile;

FIG. 20 is a report in the form of a table and a corresponding bar chart illustrating an event satisfaction rating among all attendees;

FIG. 21 is a report in the form of a table and a corresponding bar chart illustrating the top five parts of the event among all attendees;

FIG. 22 is a report in the form of a table and a corresponding bar chart illustrating attendee answers to the question whether attendees would recommend the event to their best friends (i.e. word-of-mouth);

FIG. 23 is a report in the form of a table and a corresponding bar chart illustrating attendee answers to the question whether the event changed the attendee's opinion of a brand at the event;

FIG. 24 is a report in the form of a table and a corresponding bar chart illustrating attendee answers to the question whether the event changed the attendee's consideration of a brand at the event; and

FIG. 25 is a report in the form of a table and a corresponding pie chart illustrating attendee answers to the question whether the event increased attendee purchase intention for a brand at the event.

### DETAILED DESCRIPTION OF THE PREFERRED EMBODIMENTS

In general, the present invention provides a computerized method and system for generating reports and diagnostics which measure effectiveness of an event or product or service promoted at the event. While the present invention is particularly useful for automotive products, it is to be understood that the present invention is also applicable to other products and/or services promoted at an event. Diagnostics are a measure of a particular brand's health.

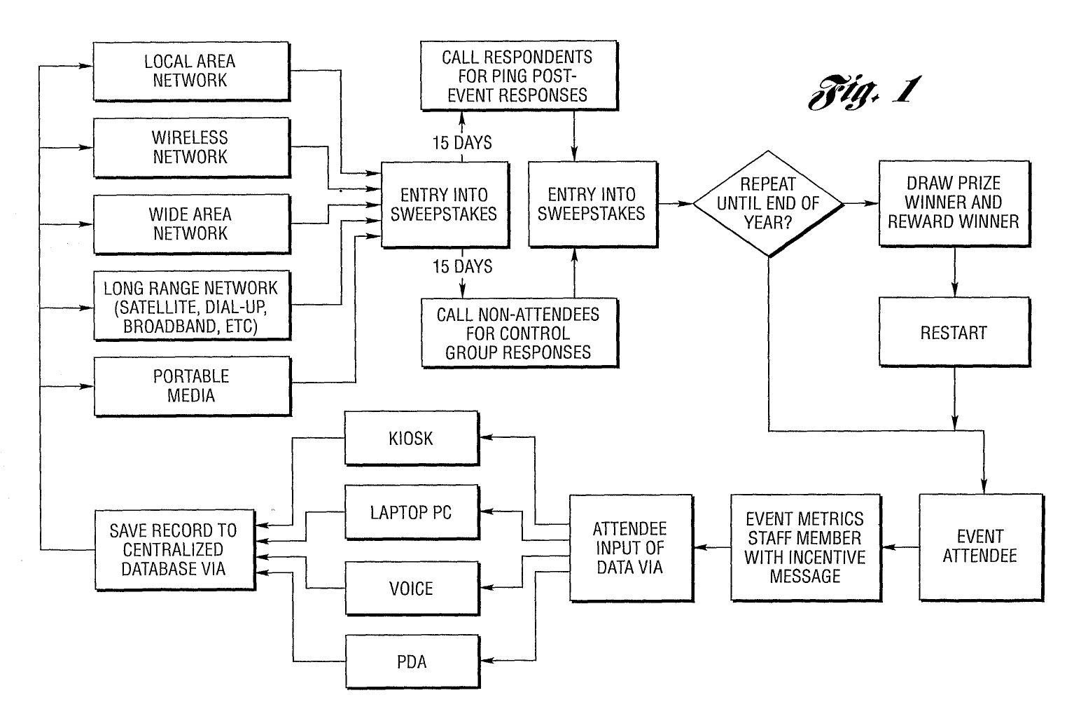

Referring now to FIG. 1, there is illustrated in block diagram flow chart form, a computerized method for generating reports which measure effectiveness of an event or product promoted at the event. In general, demographic, product and event data is obtained from attendees of the event using a plurality of interactive, attendee-accessible, data entry devices such as provided by a kiosk, laptop PCs, voice recognition devices, or personal digital assistants (i.e., PDAs). An event attendee would typically be attracted to the kiosk, the plurality of laptop PCs, voice recognition devices, or personal digital assistants by one or more individuals at a sheltered location at or near the event.

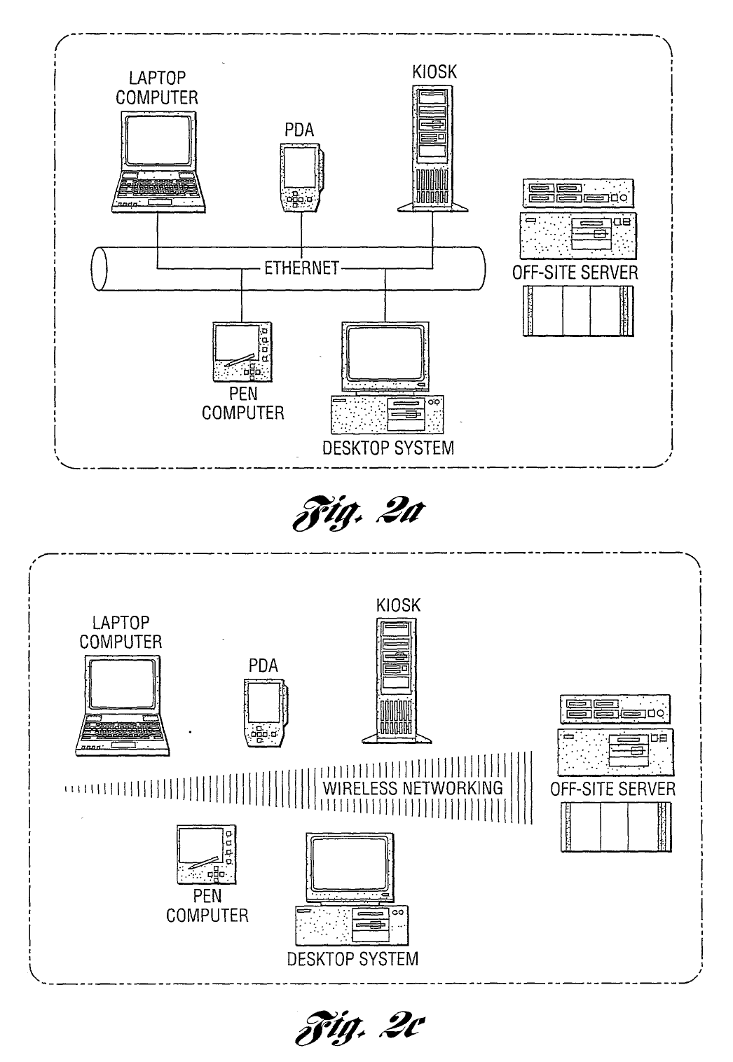

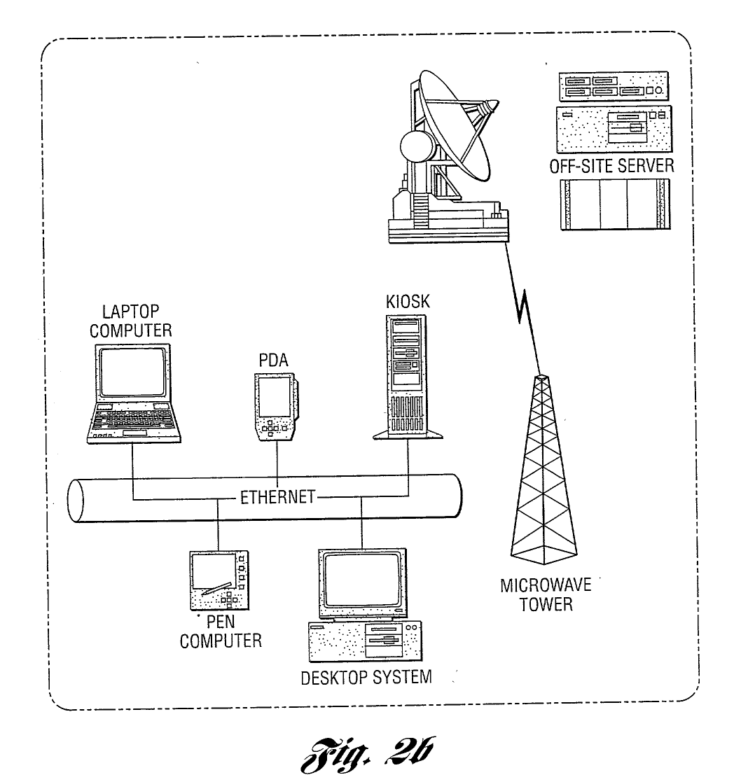

After the demographic, product and event data is obtained from the attendees, a computer network such as a local area network, a wireless network, a wide area network or a long range network (i.e., satellite dial-up broadband, etc.), as illustrated in FIGS. 2a-2c, is utilized to save the record data to a centralized database such as a server programmed with a database program. However, it is to be understood that portable storage media, such as floppy disks, CDROMs, zip disks and the like could also be used to save the record data to the centralized database.

The database program may be a relational database program. Once stored in the centralized database, the system enables instant status checking and data processing into reports and chart decks to determined whether or not marketing research targets are being reached regarding overall event effectiveness.

As illustrated in the remainder of the flow chart of FIG. 1, to induce attendees to take the survey, entries in a sweepstakes may be offered by greeters at the survey location, after which the process is repeated. The process may include, but is not limited to, on-site (at event), pre-event and post-event data gathering via mail (electronic or other), personal and/or telephone survey.

Referring now to FIG. 3, there is illustrated a “welcome” display screen that can be viewed by an attendee of the event together with an associated block diagram flow chart which illustrates what is happening at the software level.

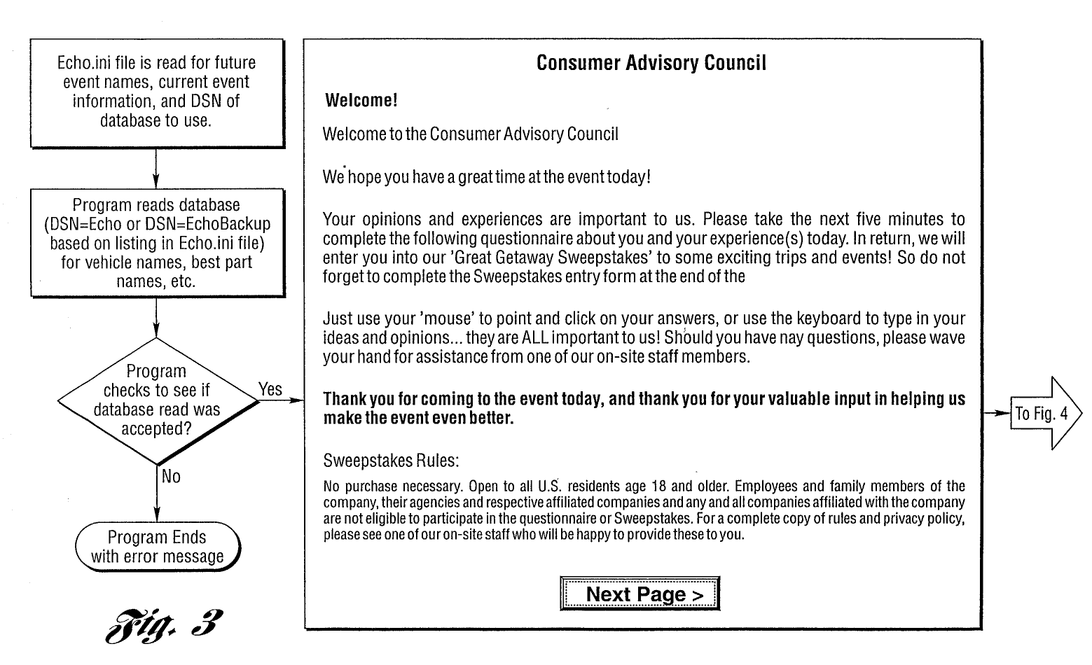

Referring now to FIG. 4, a first demographic display screen is illustrated which is viewed by an attendee. The display screen solicits various personal information of the attendee. The associated block diagram flow chart indicates a decision branch based on how the attendee answered the question, “Do you personally use a computer at home, work or elsewhere?” The display screen of FIG. 4 follows the display screen illustrated in FIG. 3.

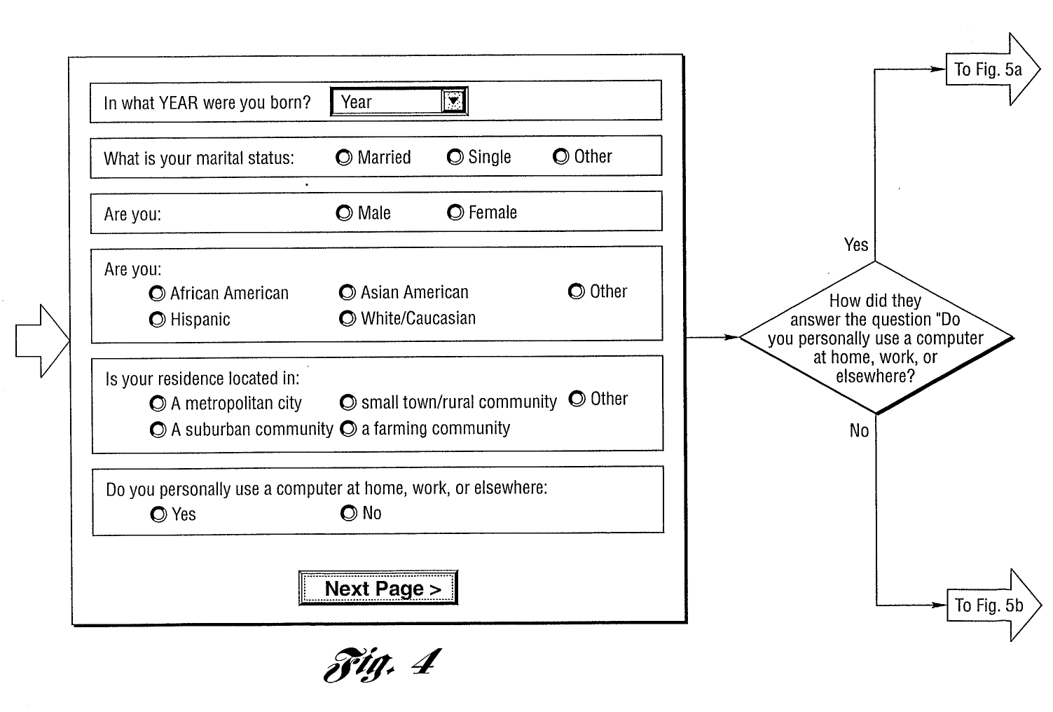

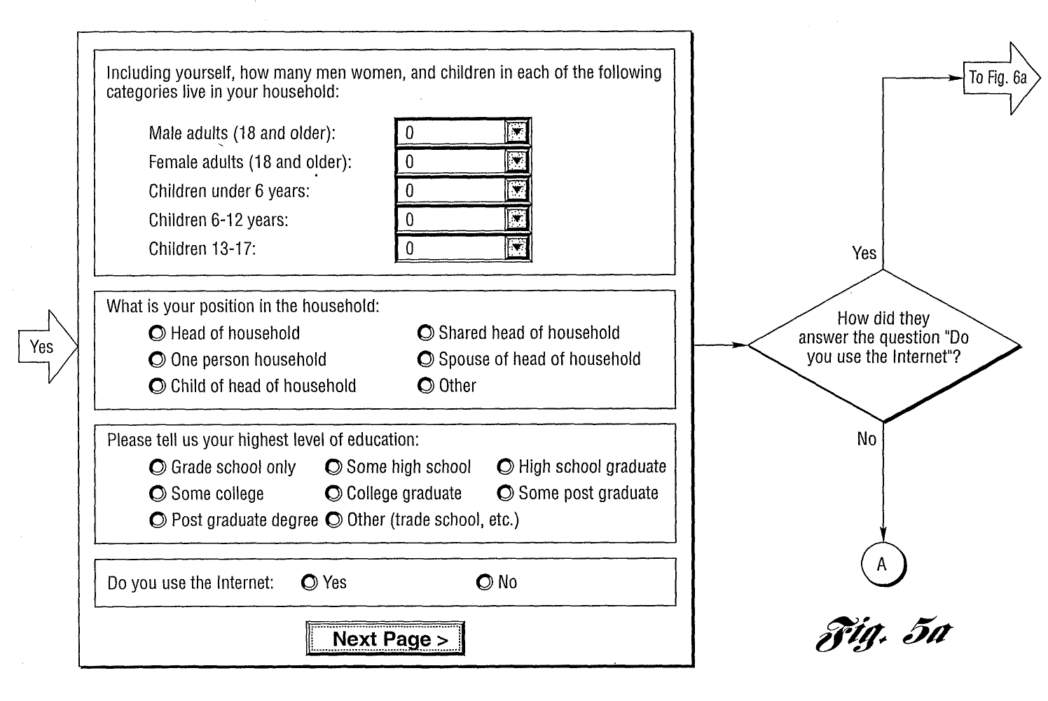

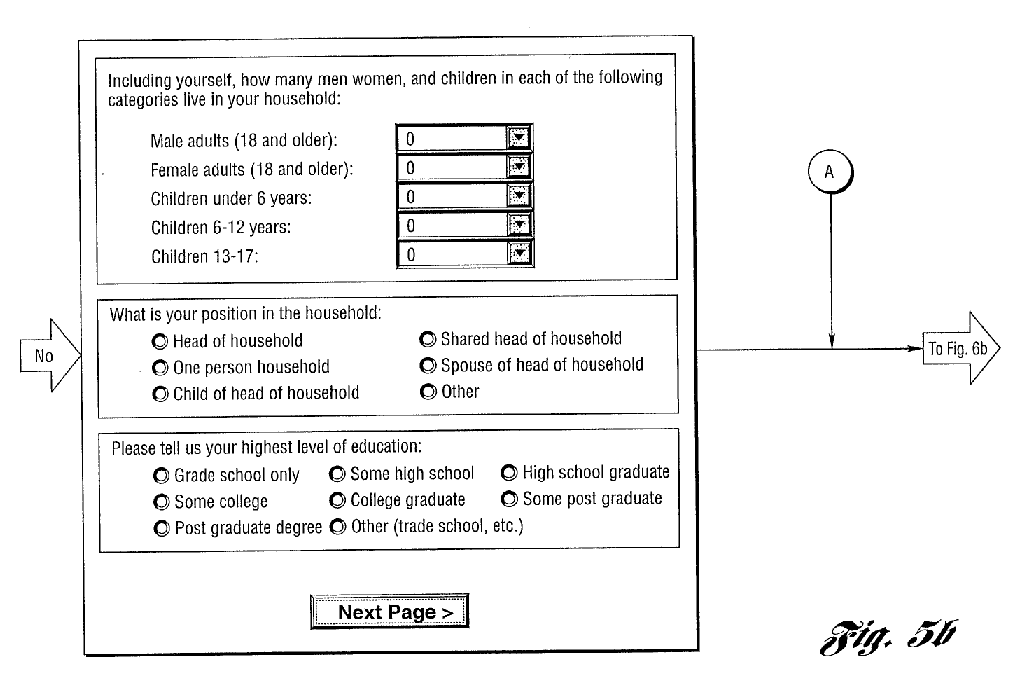

Referring now to FIGS. 5a and 5b, a pair of demographic display screens are illustrated with and without Internet questions, respectively, depending on how the attendee answered the question posed in the display screen of FIG. 4. As illustrated in the flow chart, if the attendee answers the question, “Do you use the Internet?” with a “yes,” the display screen of FIG. 5a is presented, and if the attendee answers the question “Do you use the Internet?” with a “no,” the display screen of FIG. 5b is presented.

Referring now to FIGS. 6a and 6b, a pair of demographic display screens are illustrated with and without Internet questions, respectively. If the answer “yes” is provided as noted in FIG. 5a, then the display screen of FIG. 6a is presented to the attendee, whereas if the attendee answers the question of FIG. 5b in a negative fashion, then the display screen of FIG. 6b is presented to the attendee. On the right-hand side of FIG. 6a, the decision block with the question “What is your marital status?” is entered and if the attendee indicates “married” or “other”, the upper track is taken, whereas if the attendee answers “not married” then the lower track is taken.

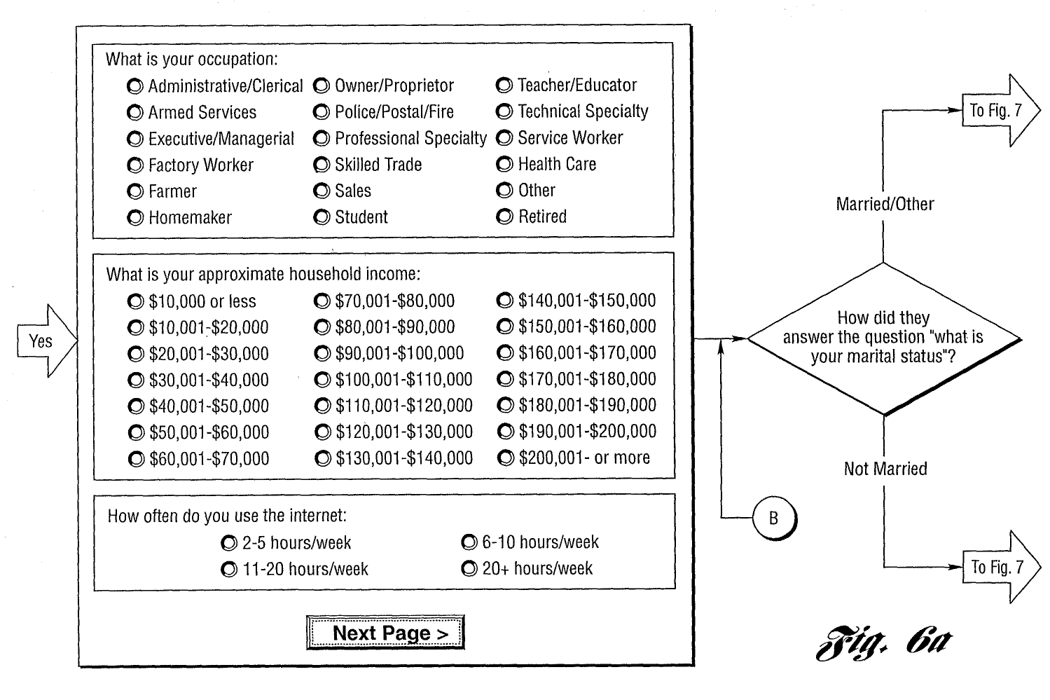

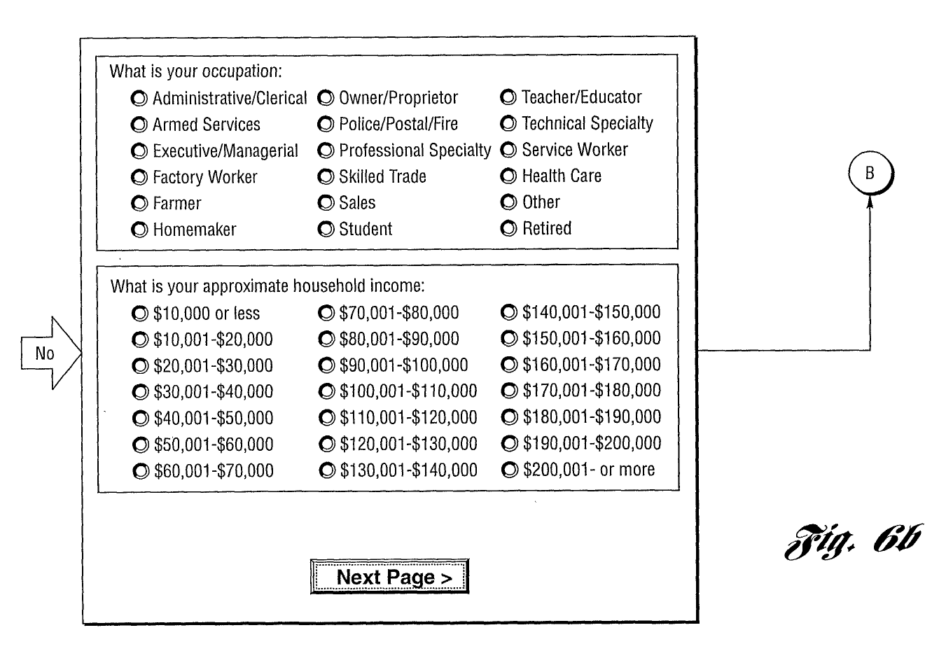

Referring now to FIG. 7, another pair of demographic display screens are alternatively provided to the attendee of the event based on the prior answer to the marriage question of FIG. 4. In the upper display screen, a spouse question is provided whereas in the lower display screen, a non-spouse question is provided. As indicated on the right-hand side of FIG. 7, a decision block of the program which asks the question whether the attendee indicated he/she was retired or not in response to the employment question of FIG. 6a or 6b is entered and if the attendee is retired, the upper track of FIG. 7 is taken whereas if the attendee indicates that he/she is not retired, the lower track is taken.

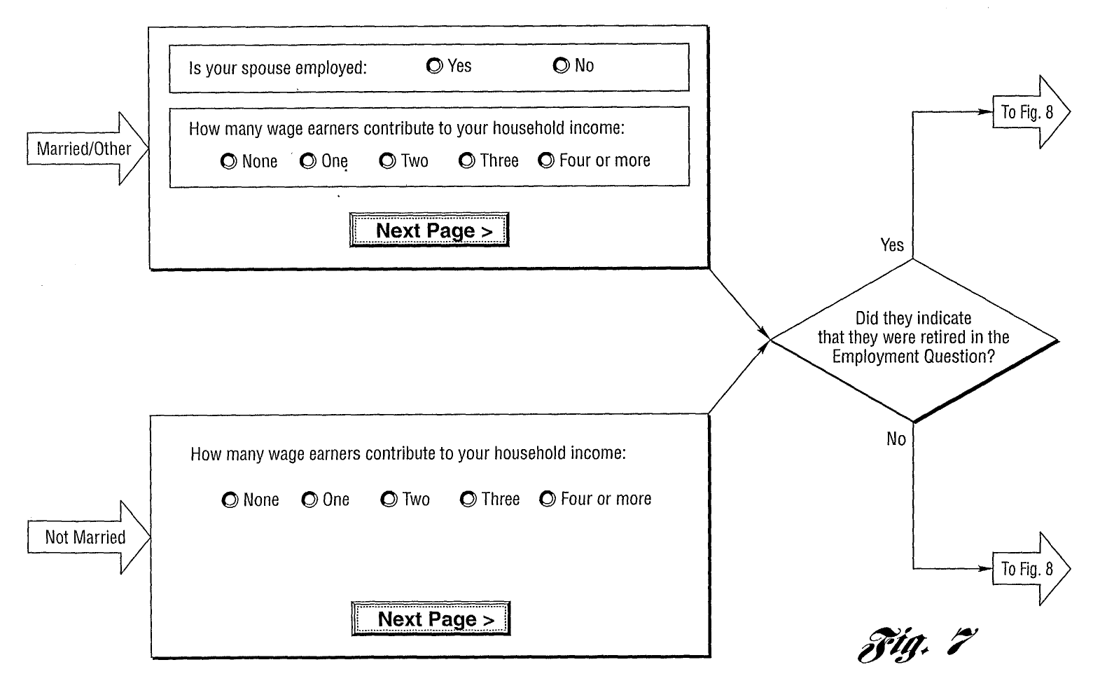

Referring now to FIG. 8, a retiree display screen is provided to the attendee if the answer is “yes” from FIG. 7. If the answer is “no,” then the attendee is immediately presented with a vehicle display screen as indicated in the lower portion of FIG. 8. After the vehicle display screen is provided to the attendee, a decision block of whether the attendee indicated that their next vehicle would be new or used is entered. If the attendee indicated that their next vehicle would be a new vehicle, the upper track of FIG. 8 is taken whereas if it is indicated that their next vehicle would be a used vehicle, the lower track is taken.

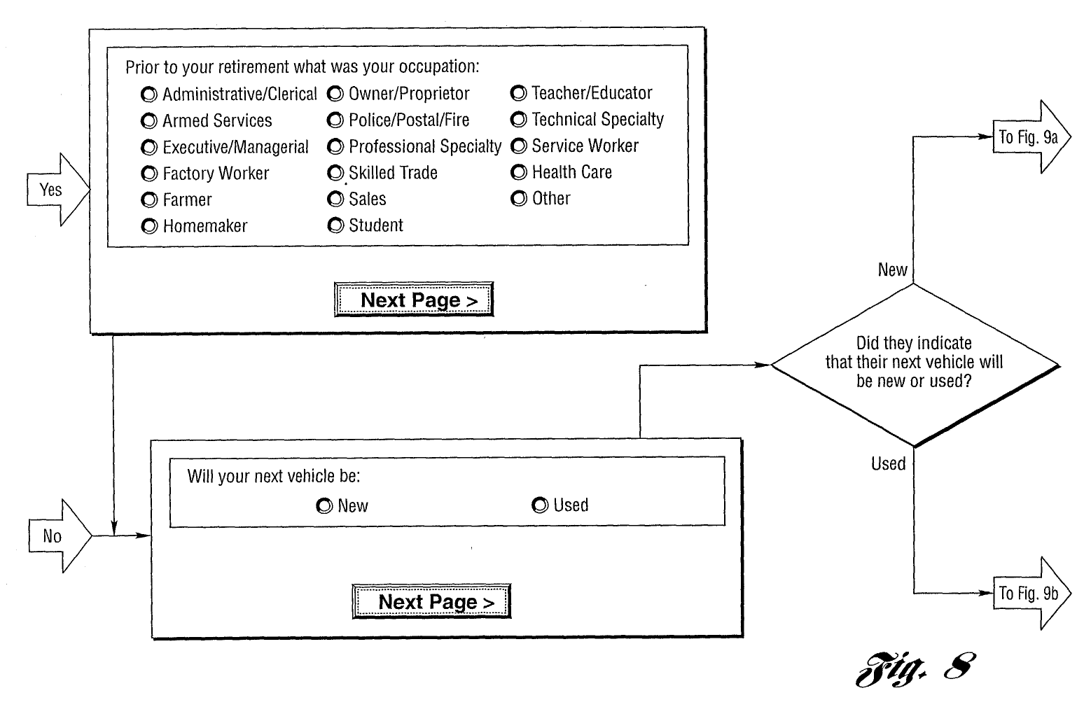

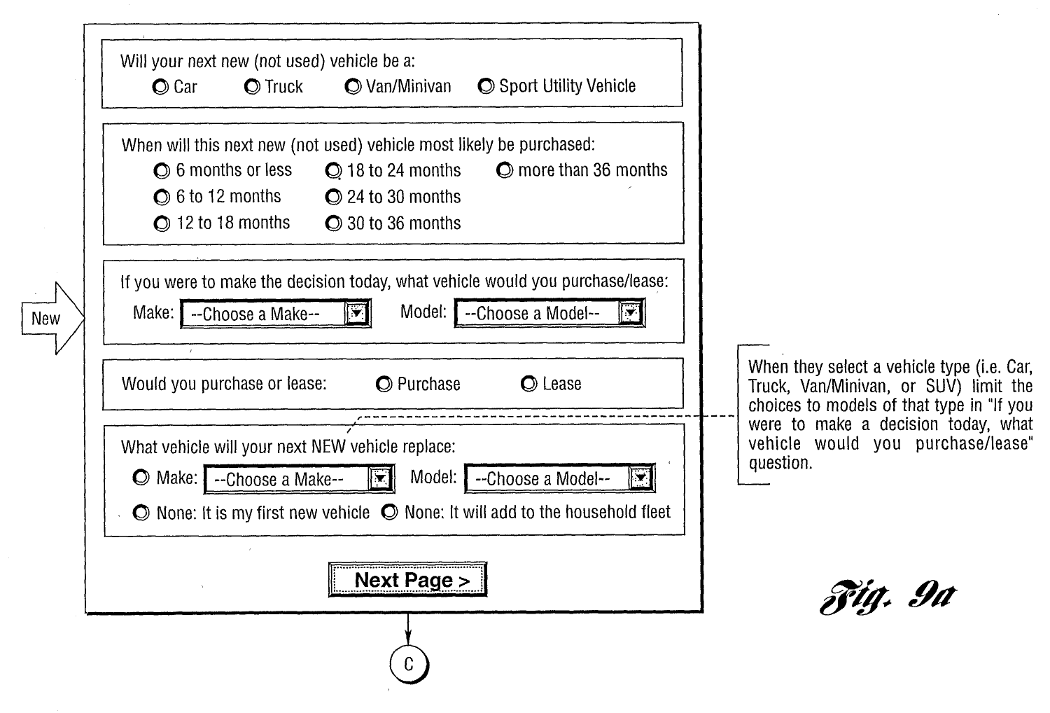

Referring now to FIGS. 9a and 9b, another vehicle display screen is provided to the attendee based on whether the attendee indicated that their next vehicle purchase would be a new vehicle, respectively. The vehicle display screen of FIG. 9b is immediately entered if the attendee indicated in the answer to the question of FIG. 8 that their next vehicle purchase would be a used vehicle. When the attendee selects a vehicle type (i.e., car, truck, van/minivan, or SUV), the choices are limited to models of that type in “If you were to make the decision today, what vehicle would you purchase/lease?”

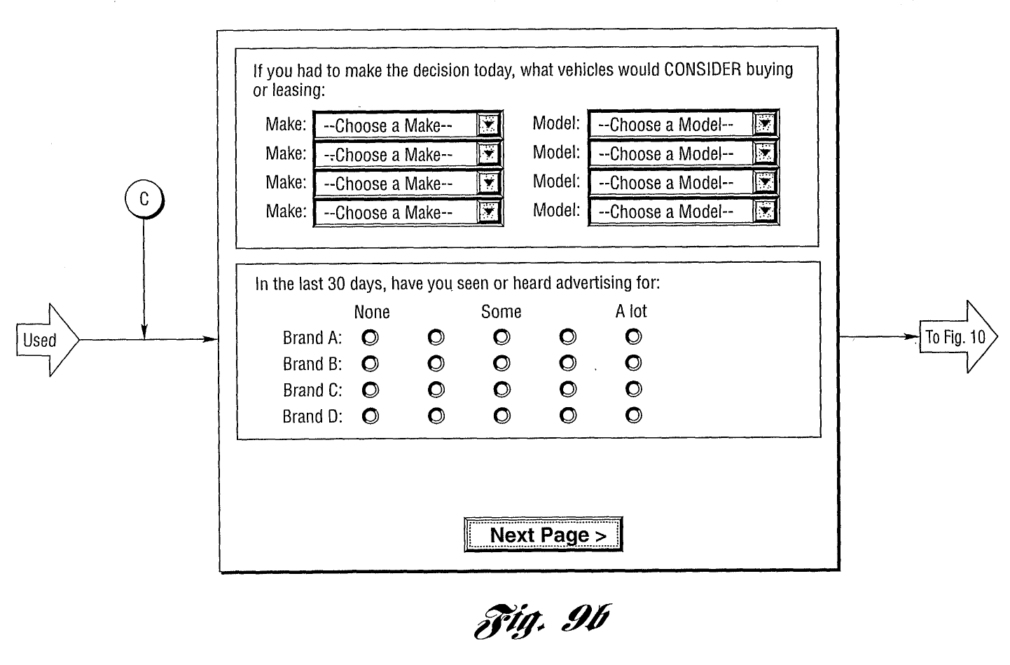

Referring now to FIG. 10, the next vehicle display screen is then provided to the attendee. If the attendee indicates that they have a vehicle (add to household fleet or replacing a vehicle) No Vehicle is disabled. If they indicate they are replacing a vehicle, that vehicle is filled into the Make and Model spaces.

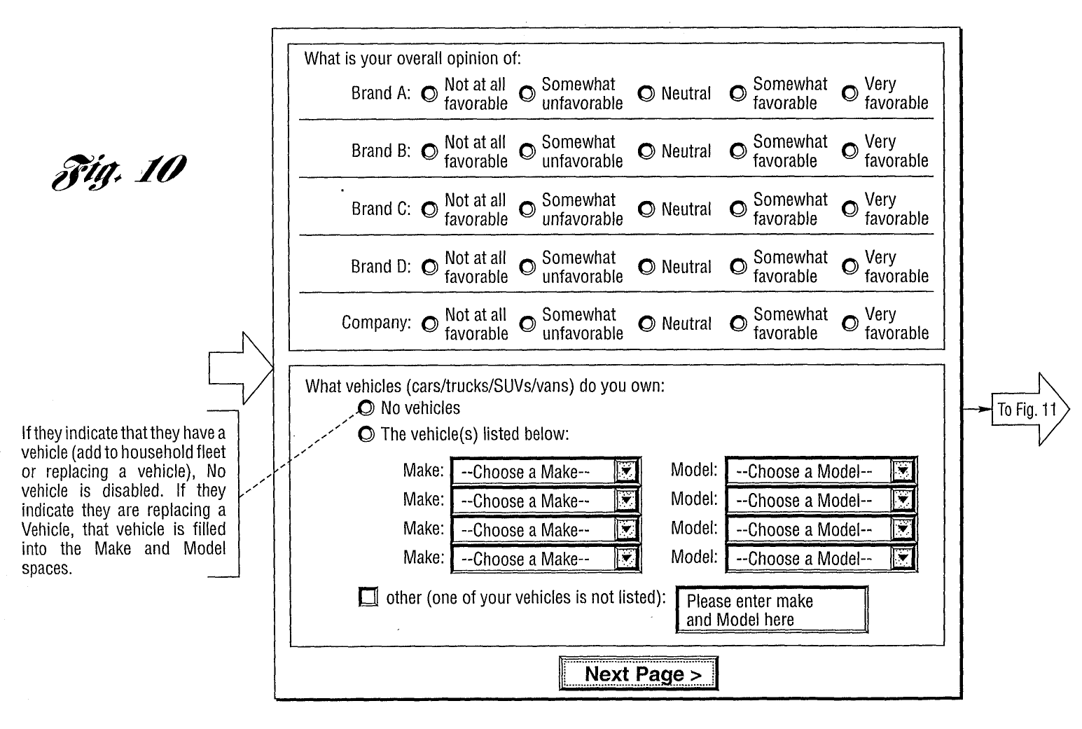

Referring now to FIG. 11, the next vehicle display screen is provided to the attendee of the event, as indicated by the generic display screen on the left-hand side of FIG. 11. If “yes” is chosen for the dealership shopping question, a space for the entry of up to three makes/models is added as indicated by the screen display in the upper right-hand corner of FIG. 11. If the respondent uses the Internet, an Internet shopping question is asked, as indicated in the screen display of the lower right-hand part of FIG. 11.

Referring now to FIG. 12, an event display screen is then provided to the attendee wherein the attendee is invited to provide an extended answer.

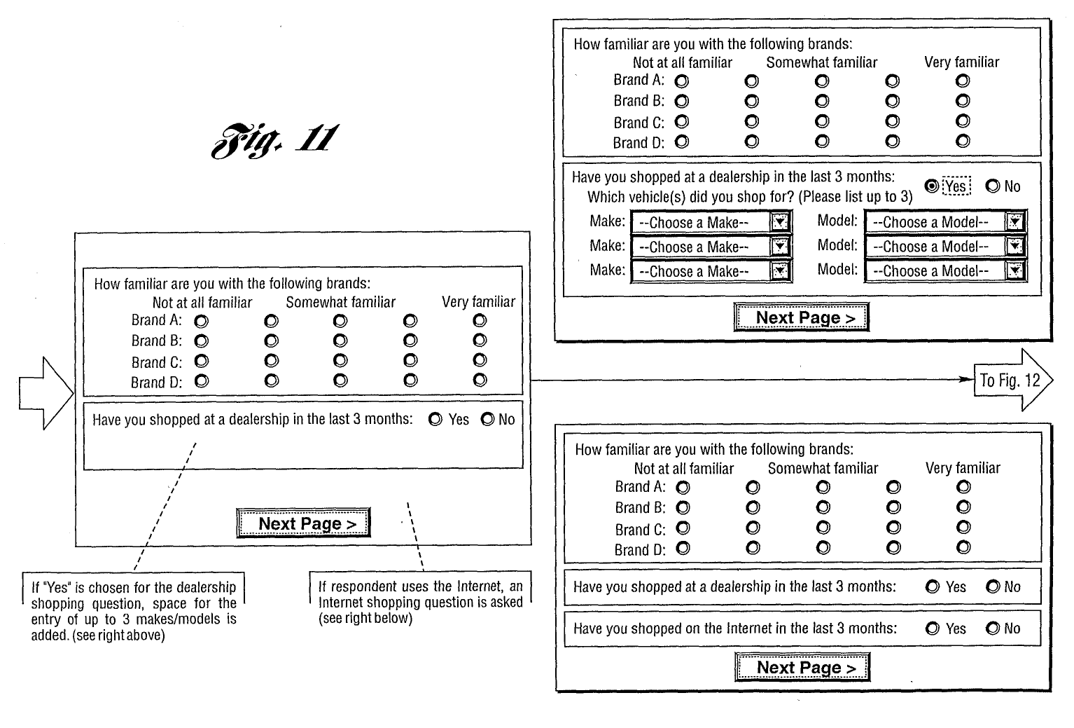

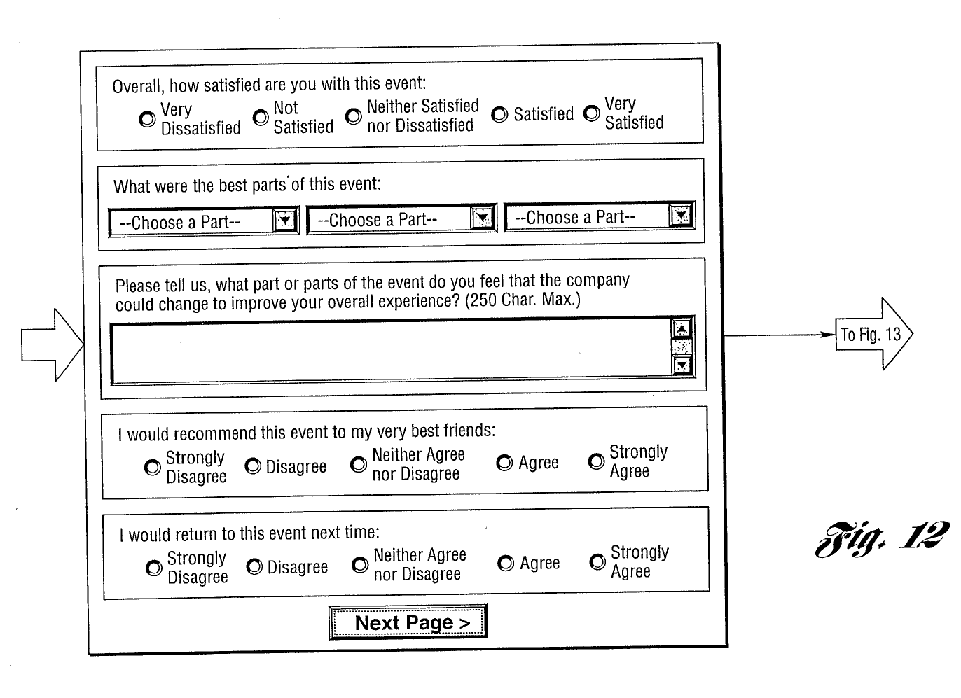

Referring now to FIG. 13, another event display screen is provided to the attendee wherein the attendee is invited to provide extended answers.

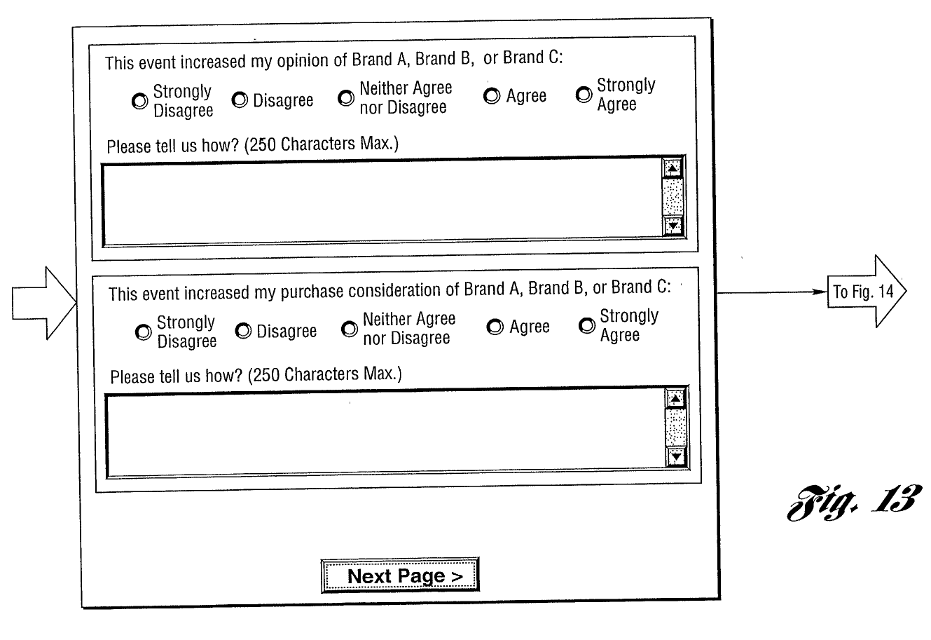

Referring now to FIG. 14, yet another event display screen is provided to the attendee.

Referring to FIG. 15, yet another event display screen is provided to the attendee.

Referring to FIG. 16, a partnership display screen is provided to the attendee wherein the hobbies (passion points) selected in the display screen of FIG. 14 are filled into the sentence “You indicated that you enjoy . . . ” and into the titles of the list boxes in the display screen of FIG. 16.

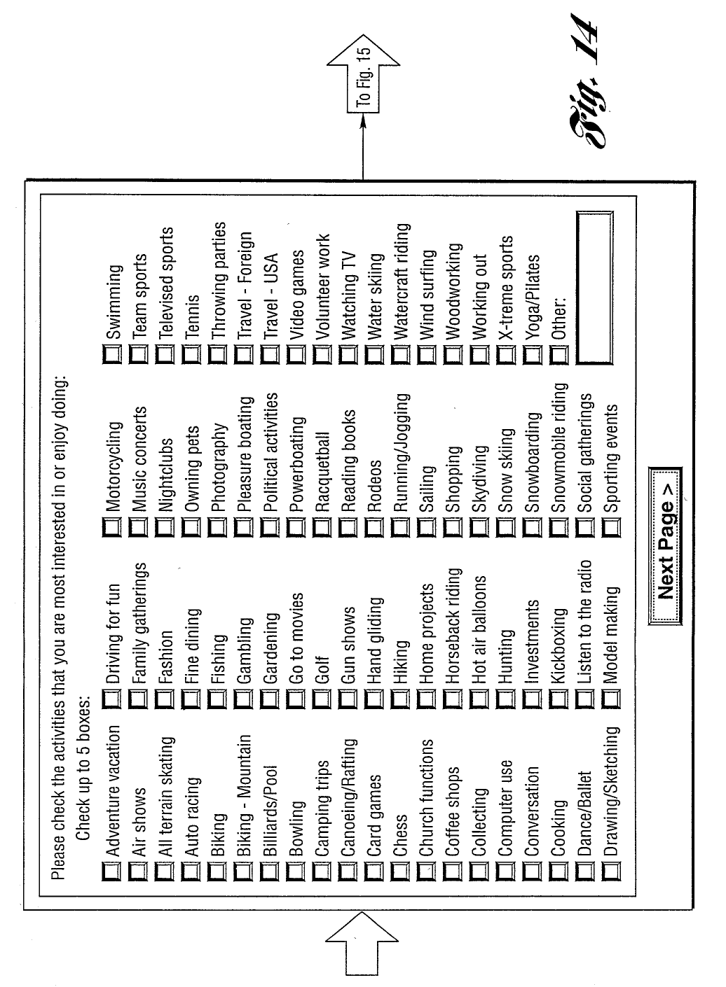

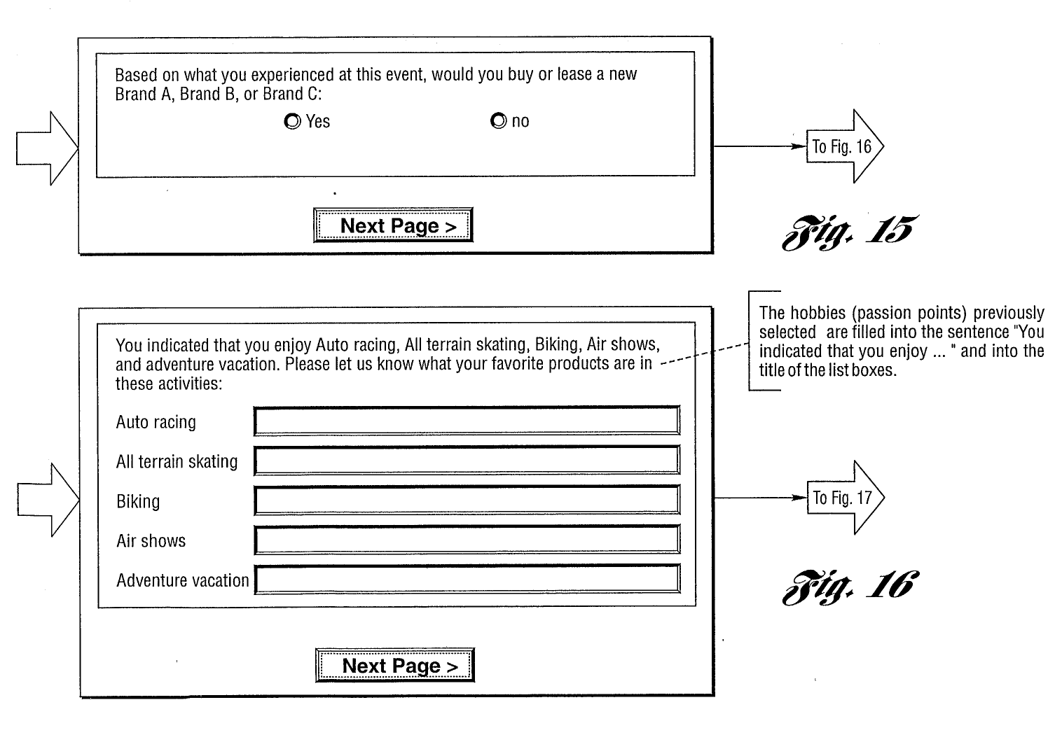

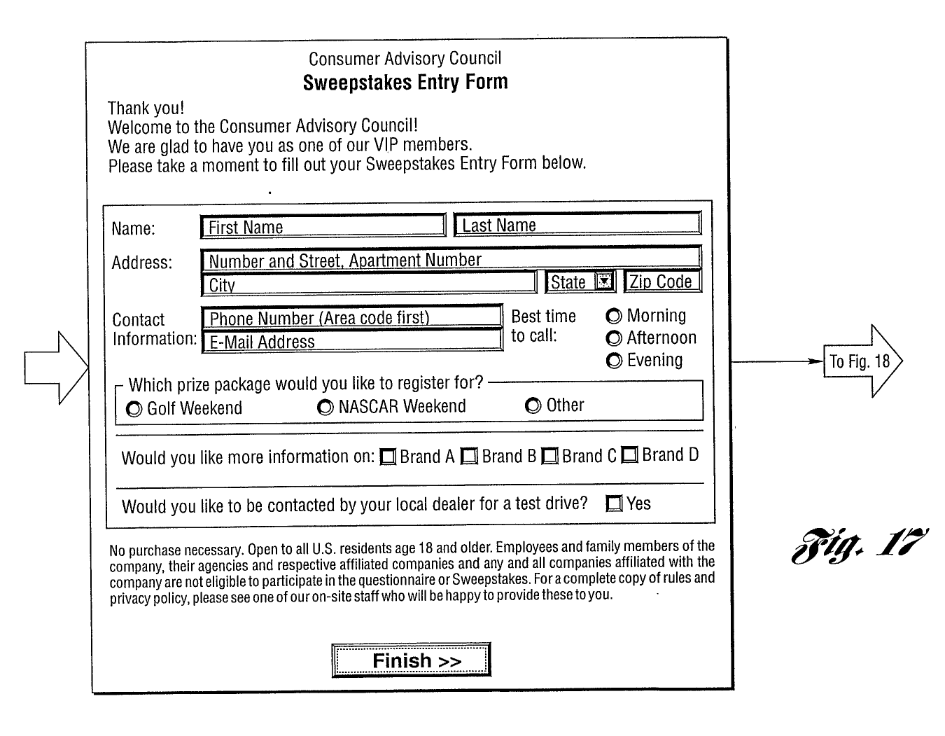

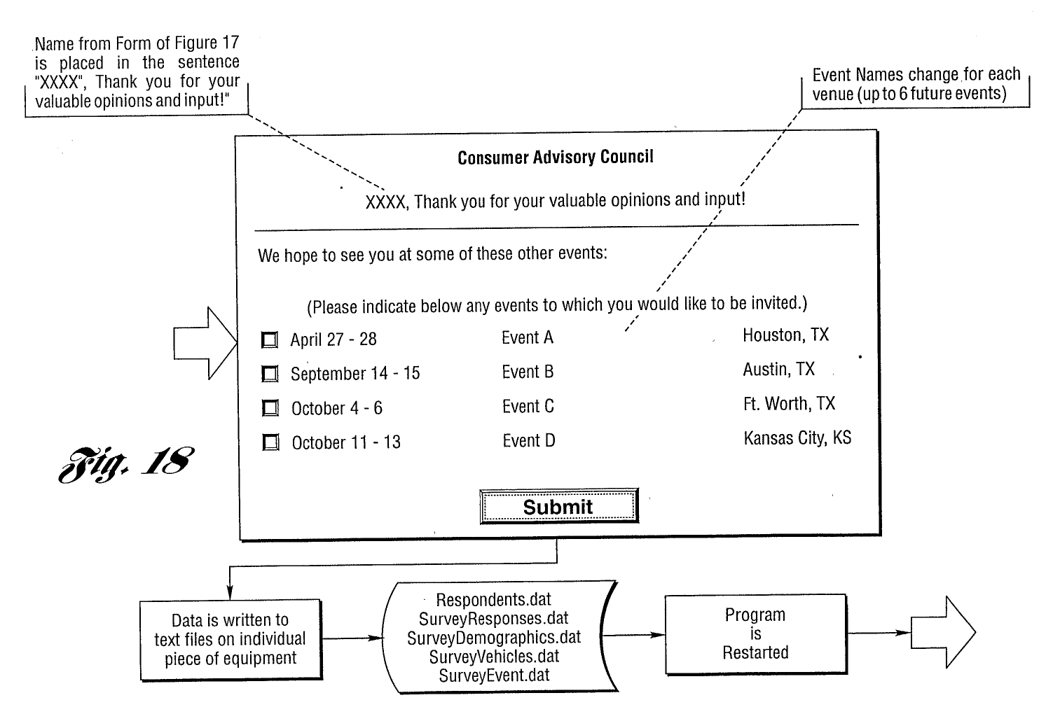

Referring now to FIG. 17, a raffle information or sweepstakes display screen is provided to the attendee. The information entered by the attendee is utilized in the sweepstakes portion of the flow chart of FIG. 1. Also, the attendee is questioned as to whether he/she would like more information on the products promoted at the event and whether they would like to be contacted by a local dealer for the product.

Referring now to FIG. 18, a “goodbye” display screen is provided to the attendee of the event. The name from the raffle information is placed in the sentence “XXXX,” “Thank you for your valuable opinions and input.” As indicated in the lower portion of the display screen of FIG. 18, Event Names change for each venue (up to six feature events). The lower portion of FIG. 18 indicates the remainder of the flow chart of the software program of the invention.

Referring now to FIG. 19, there is shown diagnostics in the form of side-by-side national and event consumer purchase funnels or profiles to enable easy comparison for a sponsor of the event. The source information for the national funnel is typically the company which provides or promotes the brand at the event. The company typically collects this data on a national scale. The sources and calculations of the event funnel profile is as follows:

Awareness: Top Two Box from Question: “How familiar are you with XXX product/brand?” Uses a scale of 1 to 5 with “5” as most familiar. Reported as a percentage of base. Base can be all event attendees, brand purchase intenders, etc.

Favorable Opinion: Top Two Box from Question: “What is your opinion of XXX product/brand?” Uses a scale of 1 to 5 with “5” as most favorable. Reported as a percentage of base. Base can be all event attendees, brand purchase intenders, etc.

Consideration: Percent of those who list XXX product/brand on their list of competitive products/brands “considered” from question, “Please list (ex: up to three) of those products/brands you would consider in your next purchase.” Can be aided or unaided question (giving respondents a list to choose from or “write-in” boxes).

Shopping: Reported as percent of those who have shopped in the last XX (ex: 90) days for products in specified category. Question is qualified with “Have you shopped for XXX (product type) in the last XX days?” If yes, please list those products/brands shopped. “Please list (ex: up to three) of those products/brands you shopped. Can be an aided or unaided question (giving respondents a list to choose from or “write-in” boxes).

First Choice Preference: Listed as a percent of base (base can be all event attendees, brand purchase intenders, etc.) from question, “If you had to make the decision today, what ONE product/brand would you purchase/lease/rent, etc.?”

Advertising Awareness: Reported as a percent of base (base can be all event attendees, brand purchase intenders, etc.) using a scale of 1 to 5 where “5” is “a lot” and 1 is “none”, “. . . in the last xx days (ex: 90), have you seen or heard any advertising for XXX product/brand?”

Each funnel has upper and lower stages. The upper part of the diagnostic funnel (i.e., awareness, favorable opinion and consideration) provides a brand “health” indication in that it provides strategic diagnostics and defines strategist planning for the long-term.

The lower part of the diagnostic funnel (i.e., shopping, first choice preferences) also provides a brand “health” indication in that it provides tactical diagnostics and defines tactile planning for the short-term.

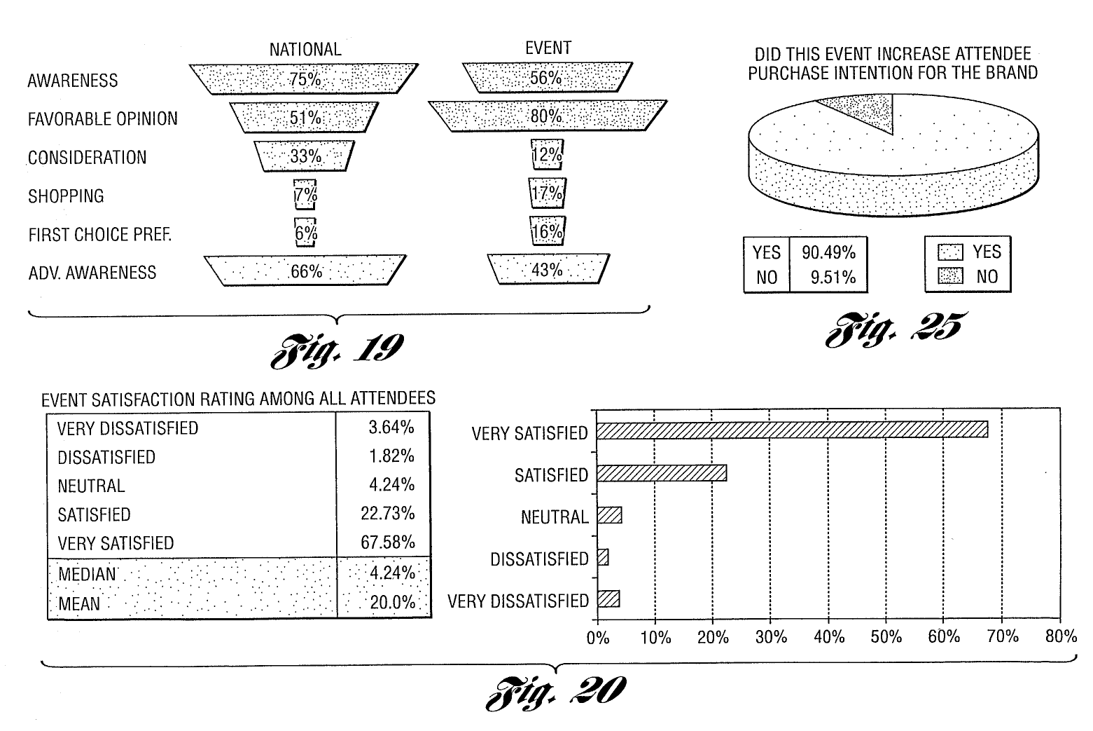

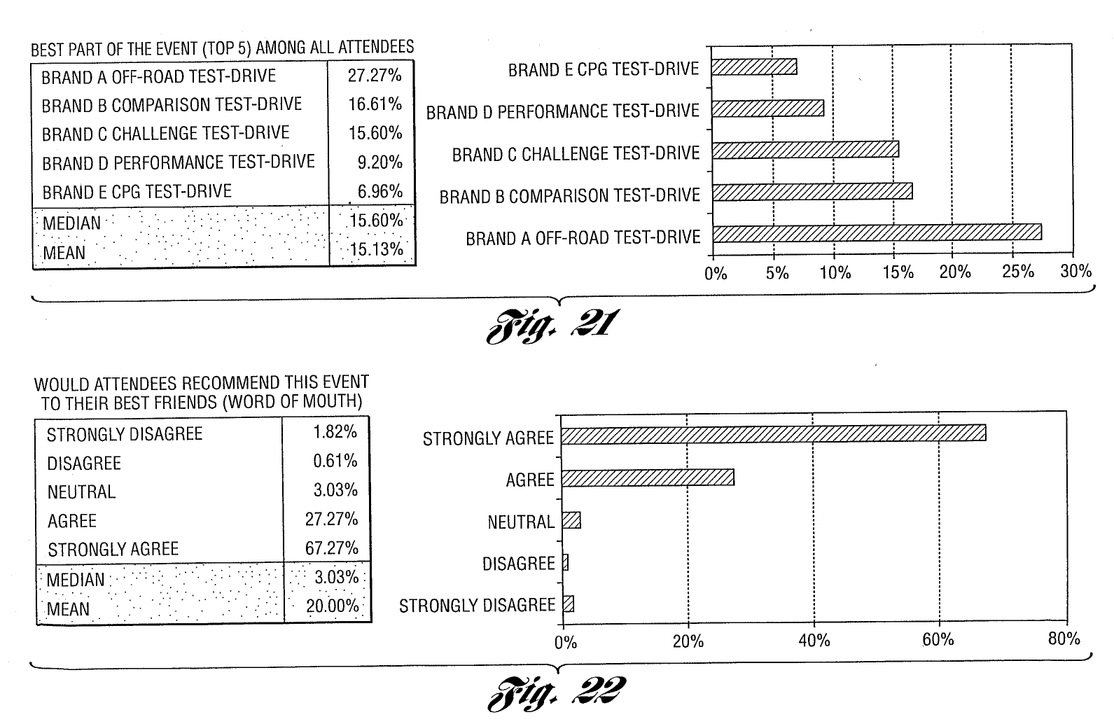

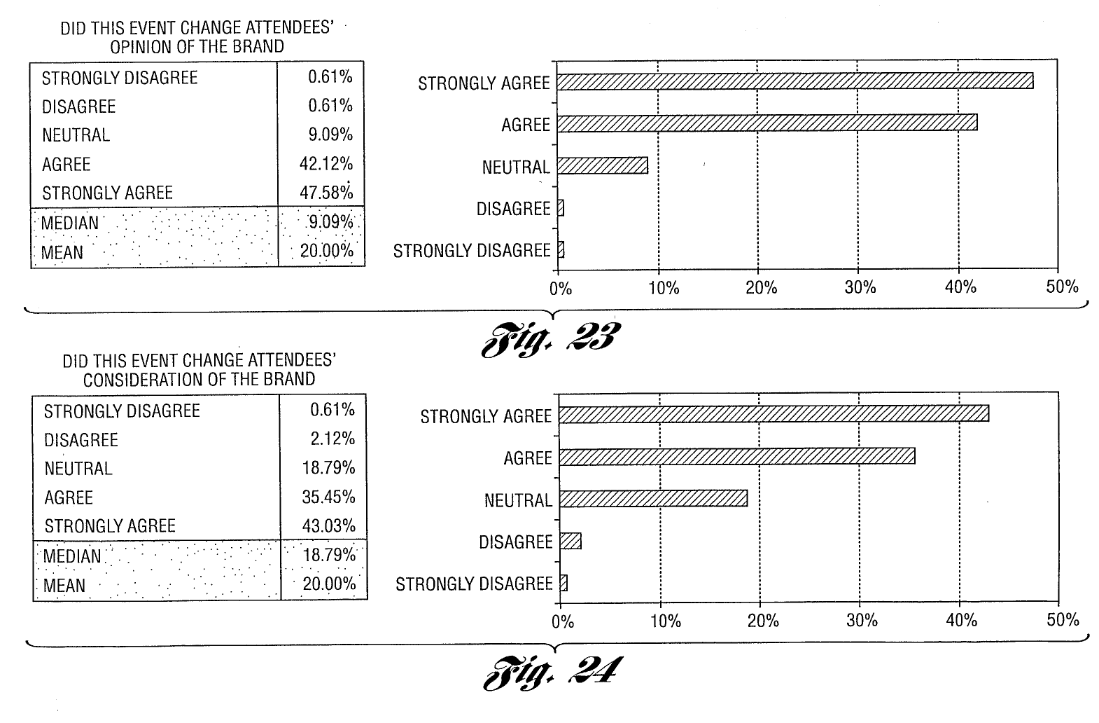

FIGS. 20-25 illustrate a variety of reports which can be generated using the method and system of the present invention. Obviously, the number and type of reports can vary according to the needs of the event sponsors.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A computerized method for generating reports and diagnostics which measure effectiveness of an event or product or service promoted at the event, the method comprising:
obtaining demographic, product or service and event data from attendees of the event using a plurality of interactive, attendee-accessible data entry devices;
storing the obtained data in an attendee database; and
processing the stored data to generate reports and diagnostics which measure effectiveness of the event or product or service.

2. The method of claim 1 wherein the step of storing is performed using a local area network.

3. The method of claim 1 wherein the step of storing is performed using a wireless network.

4. The method of claim 1 wherein the step of storing is performed using a wide area network.

5. The method of claim 1 wherein the step of storing is performed using a long range network.

6. The method of claim 1 wherein the step of storing is performed using portable storage media.

7. The method of claim 1 further comprising obtaining secondary product or service data from attendees of the event and storing the secondary product or service data in the attendee database.

8. The method as claimed in claim 1 further comprising inducing attendees to enter personal data about themselves into the data entry devices.

9. The method as claimed in claim 1 wherein the database is a relational database.

10. The method as claimed in claim 1 wherein at least one of the data entry devices includes a screen display for displaying a questionnaire and the obtained data.

11. A system for generating reports and diagnostics which measure effectiveness of an event or product or service promoted at the event, the system comprising:
a plurality of interactive, attendee-accessible data entry devices for obtaining demographic, product or service and event data from attendees of the event;
an attendee database for storing the obtained data; and
a processor for processing the stored data to generate reports and diagnostics which measure effectiveness of the event or product or service.

12. The system of claim 11 further comprising a local area network for communicating the obtained data with the database.

13. The system of claim 11 further comprising a wireless network for communicating the obtained data with the database.

14. The system of claim 11 further comprising a wide area network for communicating the obtained data with the database.

15. The system of claim 11 further comprising a long range network for communicating the obtained data with the database.

16. The system of claim 11 wherein the step of storing is performed using portable storage media.

17. The system of claim 11 wherein the data entry devices also obtain secondary product or service data from attendees of the event and the database stores the secondary product or service data.

18. The system as claimed in claim 11 further comprising means for inducing attendees to enter personal data about themselves into the data entry devices.

19. The system as claimed in claim 11 wherein the database is a relational database.

20. The system as claimed in claim 11 wherein at least one of the data entry devices includes a screen display for displaying a questionnaire and the obtained data.

21. The method as claimed in claim 1 wherein the diagnostics include an event consumer purchase funnel profile.

22. The method as claimed in claim 21 wherein the funnel includes attendees' opinion and consideration levels.

23. The method as claimed in claim 1 wherein the reports include attendee purchase intention.

24. The method as claimed in claim 1 wherein the reports include an attendee satisfaction rating.

25. The method as claimed in claim 1 wherein the reports include a personal recommendation rating.

26. The system as claimed in claim 11 wherein the diagnostics include an event consumer purchase funnel profile.

27. The system as claimed in claim 25 wherein the funnel includes attendees' opinion and consideration levels.

28. The system as claimed in claim 11 wherein the reports include attendee purchase intention.

29. The system as claimed in claim 11 wherein the reports include a personal recommendation rating.

30. The system as claimed in claim 11 wherein the reports include an attendee satisfaction rating.
